(19) United States
(12) Patent Application Publication
(10) Pub. No.: US 2023/0396611 A1
(43) Pub. Date: Dec. 7, 2023

(54) METHODS TO SECURE ACCESS TO AN AUTOMOBILE AND AN AUTHENTICATED IGNITION SYSTEM

(71) Applicant: Micron Technology, Inc., Boise, ID (US)

(72) Inventors: Sourin Sarkar, Bangalore (IN); Gowrishankar Gajendiran, Bangalore (IN); Kanika Mittal, Uttar Pradesh (IN)

(21) Appl. No.: 17/831,353

(22) Filed: Jun. 2, 2022

(51) Int. Cl. H04L 9/40; H04L 9/08

(52) U.S. Cl. CPC H04L 63/0861; H04L 9/0825

(57) ABSTRACT

In some aspects, the techniques described herein relate to a method including: receiving a radio signal by a wireless transceiver installed in a vehicle; determining that the radio signal was generated by and received from a legitimate user based on a biometric data of the legitimate user and a unique device identifier (UDI) included in the radio signal; enabling access to the vehicle; and enabling ignition of the vehicle based on the biometric data and the UDI.

### BACKGROUND

Today, most vehicles have keyless entry and push button start systems. Even if cars use floating code immobilizers, they are prone to theft. Statistically break-in to ignition times is less than 7 to 10 minutes even in a modern car. The security solution of a modern car is highly fragmented. There is no unified approach and hence it can be compromised easily. Attackers can defeat a few security perimeters in isolation and gain unauthorized access to an automobile, start the automobile, and drive away.

### BRIEF DESCRIPTION OF THE FIGURES

FIG. 1 is a block diagram of a vehicular system according to some of the example embodiments.

FIG. 2 is a block diagram of a key fob according to some of the example embodiments.

FIG. 3 is a block diagram illustrating a vehicle security system according to some of the example embodiments.

FIG. 4 is a sequence diagram illustrating a method for registering a key fob with a vehicle via a triangular authentication process according to some of the example embodiments.

FIG. 5 is a sequence diagram illustrating a method for accessing a vehicle using a key fob according to some of the example embodiments.

FIG. 6 is a flow diagram illustrating a method for detecting tampering with a key fob (or vehicle) according to some of the example embodiments.

FIG. 7 is a flow diagram illustrating a method for detecting and preventing an amplification attack according to some of the example embodiments.

FIG. 8 is a flow diagram illustrating a method for enabling and disabling the ignition of a vehicle according to some of the example embodiments.

FIG. 9 is a block diagram of a computing device according to some embodiments of the disclosure.

### DETAILED DESCRIPTION

The example embodiments provide both access protection and authenticated ignition for vehicles. The example embodiments utilize a key biometric sensor (which can registered with multiple users), a secured slave module in the key fob, a secured host module in the vehicle core, an encrypted signal from key fob to car, an amplification detection algorithm, an impersonation detection algorithm, authorization logic for service and upgrade of the firmware for key or car, a cryptographically protected mechanism for lost key replacement and provisioning, tamper protection in key fob and vehicle module, and a biometric ignition mechanism in the vehicle after unlocking the vehicle. Various combinations of these elements secure access to and use of vehicles as will be discussed.

In some aspects, the techniques described herein relate to a method including: receiving a radio signal by a wireless transceiver installed in a vehicle; determining that the radio signal was generated by and received from a legitimate user based on a biometric data of the legitimate user and a unique device identifier (UDI) included in the radio signal; enabling access to the vehicle; and enabling ignition of the vehicle based on the biometric data and the UDI.

In some aspects, the techniques described herein relate to a method, wherein the radio signal includes first user biometrics stored at a key fob, and the vehicle further stores second user biometrics and the method further includes: confirming that the first user biometrics match the second user biometrics; and writing the UDI to a secure memory in the vehicle.

In some aspects, the techniques described herein relate to a method, wherein the UDI of the key fob includes a public key of an asymmetric key pair.

In some aspects, the techniques described herein relate to a method, wherein transmitting the first user biometrics and the UDI of the key fob to the vehicle includes transmitting the first user biometrics and the UDI of the key fob to the vehicle via a short-range wireless network.

In some aspects, the techniques described herein relate to a method, wherein confirming that the first user biometrics match the second user biometrics includes determining if the first user biometrics are similar to the second user biometrics based on a threshold.

In some aspects, the techniques described herein relate to a method, further including transmitting a second UDI of the vehicle to the key fob after writing the UDI to the secure memory.

In some aspects, the techniques described herein relate to a method, wherein determining that the radio signal was generated by and received from a legitimate user further includes determining a Received Signal Strength Indicator (RSSI) of the radio signal meets a threshold.

In some aspects, the techniques described herein relate to a non-transitory computer-readable storage medium for tangibly storing computer program instructions capable of being executed by a computer processor, the computer program instructions defining steps of: receiving a radio signal by a wireless transceiver installed in a vehicle; determining that the radio signal was generated by and received from a legitimate user based on a biometric data of the legitimate user and a unique device identifier (UDI) included in the radio signal; enabling access to the vehicle; and enabling ignition of the vehicle based on the biometric data and the UDI.

In some aspects, the techniques described herein relate to a non-transitory computer-readable storage medium, wherein the radio signal includes first user biometrics stored at a key fob, and the vehicle further stores second user biometrics and the steps further include: confirming that the first user biometrics match the second user biometrics; and writing the UDI to a secure memory in the vehicle.

In some aspects, the techniques described herein relate to a non-transitory computer-readable storage medium, wherein the UDI of the key fob includes a public key of an asymmetric key pair.

In some aspects, the techniques described herein relate to a non-transitory computer-readable storage medium, wherein transmitting the first user biometrics and the UDI of the key fob to the vehicle includes transmitting the first user biometrics and the UDI of the key fob to the vehicle via a short-range wireless network.

In some aspects, the techniques described herein relate to a non-transitory computer-readable storage medium, wherein confirming that the first user biometrics match the second user biometrics includes determining if the first user biometrics are similar to the second user biometrics based on a threshold.

In some aspects, the techniques described herein relate to a non-transitory computer-readable storage medium, further including transmitting a second UDI of the vehicle to the key fob after writing the UDI to the secure memory.

In some aspects, the techniques described herein relate to a non-transitory computer-readable storage medium, wherein determining that the radio signal was generated by and received from a legitimate user further includes determining a Received Signal Strength Indicator (RSSI) of the radio signal meets a threshold.

In some aspects, the techniques described herein relate to a device including: a wireless transceiver; and a processor configured to: receive a radio signal via the wireless transceiver; determine that the radio signal was generated by and received from a legitimate user based on a biometric data of the legitimate user and a unique device identifier (UDI) included in the radio signal; enabling access to a vehicle housing the device; and enabling ignition of the vehicle based on the biometric data and the UDI.

In some aspects, the techniques described herein relate to a device, wherein the radio signal includes first user biometrics stored at a key fob, and the device further includes a secure memory storing second user biometrics, the processor further configured to: confirm that the first user biometrics match the second user biometrics; and write the UDI to a secure memory in the vehicle.

In some aspects, the techniques described herein relate to a device, wherein the UDI of the key fob includes a public key of an asymmetric key pair.

In some aspects, the techniques described herein relate to a device, wherein transmitting the first user biometrics and the UDI of the key fob to the vehicle includes transmitting the first user biometrics and the UDI of the key fob to the vehicle via a short-range wireless network.

In some aspects, the techniques described herein relate to a device, wherein confirming that the first user biometrics match the second user biometrics includes determining if the first user biometrics are similar to the second user biometrics based on a threshold.

In some aspects, the techniques described herein relate to a device, wherein determining that the radio signal was generated by and received from a legitimate user further includes determining a Received Signal Strength Indicator (RSSI) of the radio signal meets a threshold.

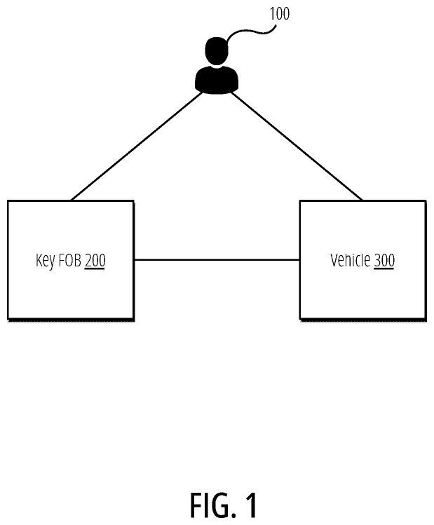

FIG. 1 is a block diagram of a vehicular system according to some of the example embodiments.

In an embodiment, a user 100 can physically access both a key fob 200 and a vehicle 300. Both key fob 200 and vehicle 300 can include one or more computing devices performing operations to ensure that only authorized users can access and start the vehicle 300. During normal operations, user 100 registers with both the key fob 200 and the vehicle 300. For example, upon purchasing vehicle 300, the user 100 can register with key fob 200 and vehicle 300 by providing his or her biometric measurements to the devices. As will be discussed, these biometrics can be used in a triangulated authentication scheme to ensure that only the authorized user and authorized key fob 200 can access vehicle 300. Further detail on these operations, as well as key fob 200 and vehicle 300 are described in more detail in the following description.

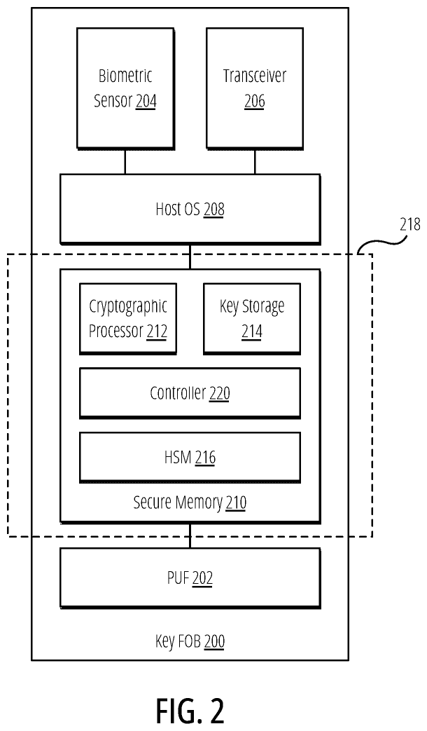

FIG. 2 is a block diagram of a key fob according to some of the example embodiments.

In an embodiment, key fob 200 can comprise an electronic, computing device design to access or operate a vehicle (e.g., vehicle 300). In an embodiment, the key fob 200 can include additional circuitry or components not illustrated in FIG. 2.

In an embodiment, the key fob 200 includes a physically unclonable function (PUF 202). In an embodiment, the PUF 202 may comprise a physical hardware circuit that exploits inherent randomness introduced during manufacturing to give a physical entity a unique ‘fingerprint’ or trust anchor. In the illustrated embodiment, the PUF 202 produces a consistent and repeatable value. In some embodiments, the PUF 202 may comprise a static random-access memory (SRAM) PUF, Delay PUF, or any other PUF technology implemented on the key fob 200. In the illustrated embodiment, hardware security module (HSM 216), and specifically the cryptographic processor 212, can read a PUF value from PUF 202 and use the PUF value during cryptographic operations, as will be discussed.

In some embodiments, the cryptographic processor 212 can compute a unique device identity (UDI) for the key fob 200 using the value of the PUF 202. In some embodiments, the UDI can comprise the value of the PUF 202 itself. In other embodiments, the value of the PUF 202 can be used by cryptographic processor 212 to generate a new UDI. For example, in some embodiments, the PUF 202 can be used as the unique device secret (UDS) in a Device Identity Composition Engine (DICE) implemented in key fob 200. In such an embodiment, the UDI can comprise an asymmetric key pair (e.g., an Elliptic Curve Digital Signature Algorithm, ECDSA, or Elliptic-curve Diffie-Hellman, ECDH, Rivest-Shamir-Adleman, RSA, or similar key pair) generated as part of a device identity generation process. In a DICE system, the UDI can comprise a DICE Device ID key or an Alias key. In general, however, other systems can be used to generate a UDI. For example, the value of the PUF 202 can be input into a symmetric key generation algorithm to generate a symmetric key as the UDI. In some embodiments, since the value of the PUF 202 is used as a seeding value, the resulting UDI can be assured to be unique to the key fob 200 (or, as will be discussed, vehicle 300).

In an embodiment, the cryptographic processor 212 can persist the UDI to a secure key storage area 214 of secure memory 210. In some embodiments, the secure key storage area 214 can comprise a persistent storage area in the secure memory 210. In some embodiments, the secure memory 210 can protect external accesses to the secure key storage area 214, thus ensuring its contents are tamper-proof. As illustrated, a security perimeter 218 can be established to protect the secure memory 210.

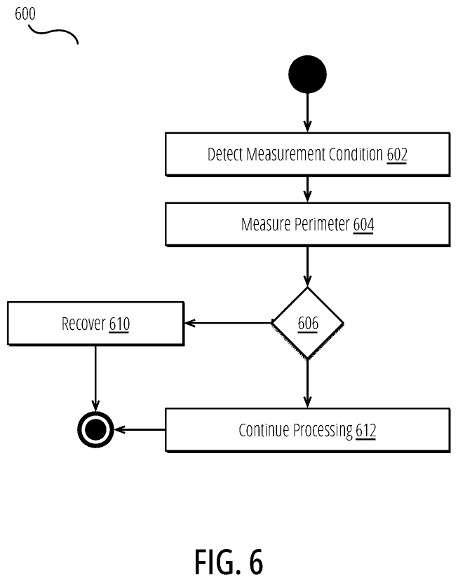

FIG. 6 is a flow diagram illustrating a method for detecting tampering with a key fob (or vehicle) according to some of the example embodiments. In some embodiments, method 600 can be executed by one or both of controller 220 and vehicle controller 324.

In some embodiments, a controller 220 executing method 600 can detect a measurement condition (step 602). In some embodiments, the measurement condition can be a startup event, a reboot event, the expiration of a timer, etc. The controller 220 can thus periodically (or on-demand) measure (step 604) the hardware and/or software properties of the security perimeter 218 and compare (step 606) the measurement to a golden measurement stored, for example, in HSM 216. If the measurements differ, controller 220 can raise an error and take corrective action (step 610). For example, in some embodiments, the HSM 216 can store a previous firmware or software image that can be used to revert the secure memory 210 to a secure state. In some embodiments, the controller 220 can erase any secure data (e.g., keys) and reset the key fob 200. By contrast, if the measurements match, the controller 220 can continue processing (step 612).

In some embodiments, the security perimeter 218 can be larger than the secure key storage area 214. In some embodiments, the security perimeter 218 can comprise the entire key fob 200. By using security perimeter 218, the key fob 200 can ensure that a malicious user cannot modify the UDI, user biometrics, or similar data to spoof authentication with a vehicle. Further, in the various embodiments, the use of PUF values prevent key cloning since a physical device is needed to generate the UDI.

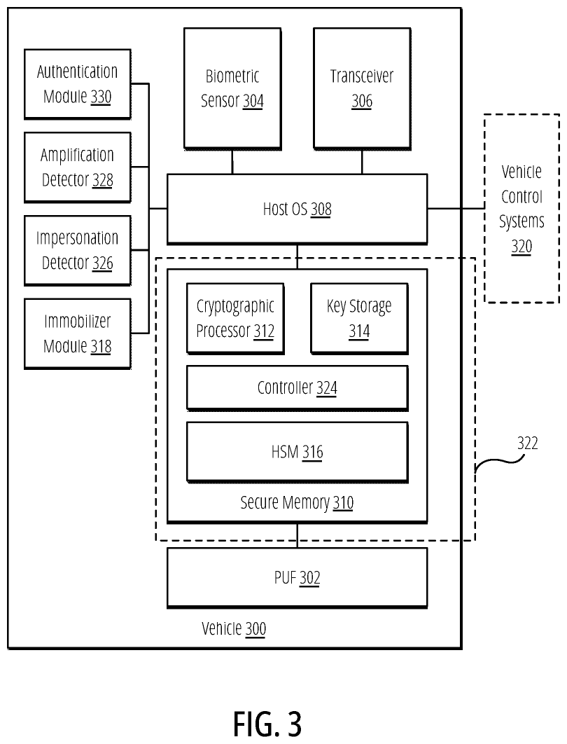

In some embodiments, the key fob 200 can configured the transceiver 206 to operate within a specific tolerance range (e.g., frequency, amplitude, etc.). As will be discussed in connection with FIG. 3, this tolerance range can be used to detect amplification or relay attacks. Specifically, in some embodiments, the radio signal output by a key fob can include a threshold range of Received Signal Strength Indicator (RSSI) values which will trigger access to a vehicle. In some embodiments, the vehicle can require that the RSSI value of the receive exceed the threshold. Since, in many scenarios, an amplification or relay attack results in a lower RSSI value, the vehicle can ignore the radio signal. In some embodiments, two thresholds can be used: an upper and lower threshold and the vehicle can require the RSSI value of a radio signal to be between the two thresholds.

In an embodiment, the key fob 200 also includes a biometric sensor 204. The biometric sensor 204 can comprise any type of sensor for reading biometric data including, but not limited to, fingerprint sensors, iris or retinal scanners, cameras, or Lidar sensors (e.g., for facial recognition), etc. In general, any sensor capable of generating a biometric measurement can be used. As will be discussed, a user's biometric measurement and the UDI generated by cryptographic processor 212 can be used to access a vehicle (e.g., vehicle 300). Although a single user may be discussed, the various embodiments can be used for multiple users associated with a vehicle. In some embodiments, the biometric measurement can be stored in an HSM 216 of the secure memory 210. In some embodiments, the use of user biometrics and a UDI value can be used to prevent impersonation attacks, discussed more in FIG. 3.

In some embodiments, during a setup procedure, a user can supply their biometrics via biometric sensor 204. For example, a user can provide their fingerprint to the key fob 200 via a fingerprint scanner. In some embodiments, the key fob 200 can be configured to activate the key fob 200 by setting a flag or other setting indicate the key fob 200 is activated. In some embodiments, the key fob 200 can set an activation setting on a per-user basis, thus allowing for multiple users to have an “activated” key fob. In some embodiments, the key activation process can be performed online or offline and no limit is placed on the network conditions of the key fob 200 during activation.

In some embodiments, after activating the key fob 200 for a given user, the host operating system 208 can be configured to enable the user at a vehicle (e.g., 300). In some embodiments, the host operating system 208 can be configured to retrieve the biometric measurement (from, for example, HSM 216 and secure memory 210) as well as the UID from secure key storage area 214 (via HSM 216). In some embodiments, the host operating system 208 can generate an enable command to transmit to the vehicle (e.g., vehicle 300) via a transceiver 206. In some embodiments, the transceiver 206 can comprise a short-range wireless transceiver such as a Bluetooth transceiver. As will be discussed, the vehicle can obtain a valid user's biometrics via an alternative channel and can validate the received command and persist the key fob 200's UDI.

FIG. 3 is a block diagram illustrating a vehicle security system according to some of the example embodiments.

In an embodiment, the vehicle 300 includes a PUF 302. In an embodiment, the PUF 302 may comprise a physical hardware circuit that exploits inherent randomness introduced during manufacturing to give a physical entity a unique ‘fingerprint’ or trust anchor. In the illustrated embodiment, the PUF 302 produces a consistent and repeatable value. In some embodiments, the PUF 302 may comprise a static random-access memory (SRAM) PUF, Delay PUF, or any other PUF technology implemented on the vehicle 300. In the illustrated embodiment, HSM 316, and specifically the cryptographic processor 312, can read a PUF value from PUF 302 and use the PUF value during cryptographic operations, as will be discussed.

In some embodiments, the cryptographic processor 3212 can compute a UDI for the vehicle 300 using the value of the PUF 302. In some embodiments, the UDI can comprise the value of the PUF 302 itself. In other embodiments, the value of the PUF 302 can be used by cryptographic processor 312 to generate a new UDI. For example, in some embodiments, the PUF 302 can be used as the UDS in a DICE implemented in vehicle 300. In such an embodiment, the UDI can comprise an asymmetric key pair (e.g., an ECDSA, ECDH, RSA, or similar key pair) generated as part of a device identity generation process. In a DICE system, the UDI can comprise a DICE Device ID key or an Alias key. In general, however, other systems can be used to generate a UDI. For example, the value of the PUF 302 can be input into a symmetric key generation algorithm to generate a symmetric key as the UDI. In some embodiments, since the value of the PUF 302 is used as a seeding value, the resulting UDI can be assured to be unique to the vehicle 300.

In an embodiment, the cryptographic processor 312 can persist the UDI to a secure key storage area 314 of secure memory 310. In some embodiments, the secure key storage area 314 can comprise a persistent storage area in the secure memory 310. In some embodiments, the secure memory 310 can protect external accesses to the secure key storage area 314, thus ensuring its contents are tamper-proof. As illustrated, a security perimeter 322 can be established to protect the secure memory 310. In some embodiments, a controller 324 can periodically (or on-demand) measure the hardware and/or software properties of the security perimeter 322 and compare the measurement to a golden measurement stored, for example, in HSM 316. If the measurements differ, controller 324 can raise an error and take corrective action. For example, in some embodiments, the HSM 316 can store a previous firmware or software image that can be used to revert the secure memory 310 to a secure state. In some embodiments, the controller 324 can erase any secure data (e.g., keys) and reset the vehicle 300. In some embodiments, the security perimeter 322 can be larger than the secure memory 310. By using security perimeter 322, vehicle 300 can ensure that a malicious user cannot modify the UDI, user biometrics, or similar data to spoof authentication with a vehicle. Further, in the various embodiments, the use of PUF values prevent key cloning since a physical device is needed to generate the UDI.

In an embodiment, host operating system 308 can be configured to receive data from biometric sensor 304 and transceiver 306 as well as provided data to Authentication Module 330, secure key storage area 314, HSM 316, and immobilizer module 318. The host operating system 308 also accesses secure data from secure memory 310. Ultimately, host operating system 308 can be responsible for instructing the vehicle control systems 320 to perform actions after confirming the identity of a user.

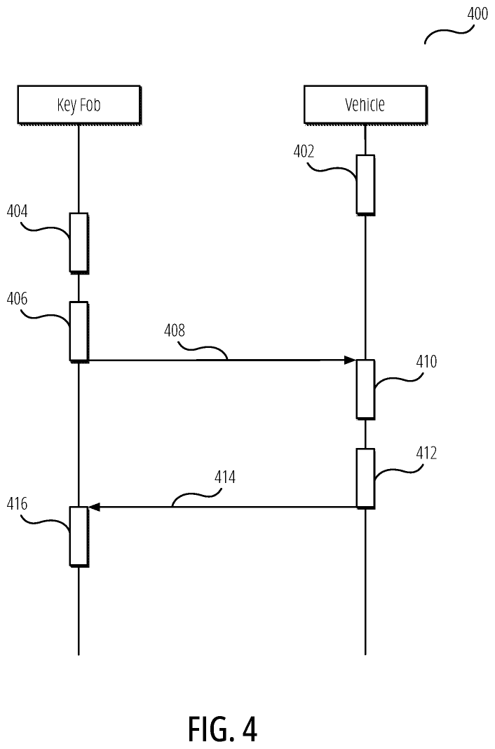

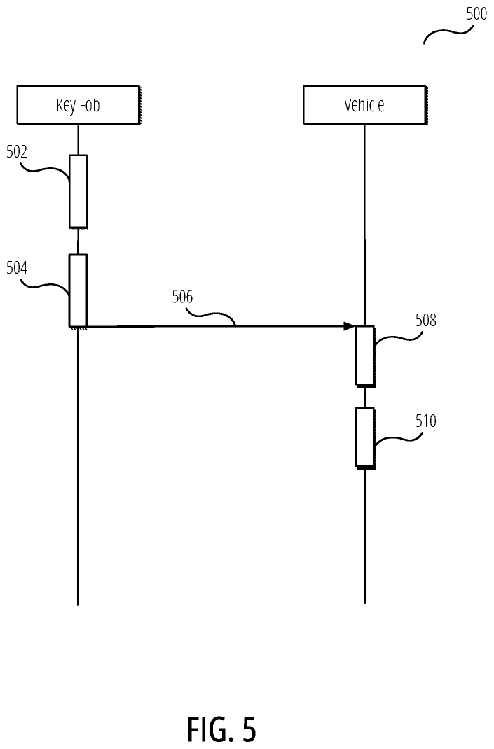

In an embodiment, the authentication module 330 can be configured to authenticate a user (via a key fob). In some embodiments, the authentication module 330 can be configured to register users. In an embodiment, the authentication module 330 can receive a user's biometrics via the biometric sensor 304. In some embodiments, these biometric measurements can be stored in HSM 310. As discussed, the biometric measurement received via biometric sensor 304 is independent of that received via the key fob. Thus, a single user must provide biometrics twice, once at the key fob and once via biometric sensor 304 as discussed in FIG. 4. In this manner, the physical presence of a user is required in both instances. During registration, the host operating system 308 receives a command from the key fob via the transceiver 306. As discussed, this command can include biometrics sent from the key fob as well as the key fob's UDI. In an embodiment, the authentication module 330 can compare the biometrics received from the key fob with the biometrics stored in secure memory 310. If the biometrics match, the authentication module 330 can confirm that the key fob issuing the registration command should be registered as user. In response, the Authentication module 330 can transmit the received key fob UDI to secure key storage area 314 for secure, persistent storage. Further details of authentication module 330 are provided in FIG. 5.

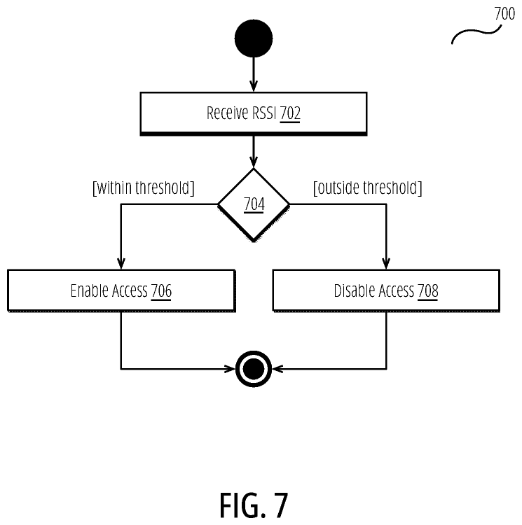

In an embodiment, the vehicle 300 can include an amplification detector 328. In an embodiment, the amplification detector 328 can monitor radio signals received via transceiver 306 and can provide a responsive radio signal to host operating system 308 to enable or disable operations based on whether the monitored radio signals represent an amplification or relay attack. Further detail on secure key storage area 314 is provided in FIG. 7.

FIG. 7 is a flow diagram illustrating a method for detecting and preventing an amplification attack according to some of the example embodiments. In some embodiments, method 700 can be performed by amplification detector 328. In step 702, method 700 can include receiving an RSSI value for a radio signal detected via, for example, transceiver 306. In some embodiments, the transceiver 306 can generate an RSSI value for a given radio signal received and forward the radio signal to host operating system 308. Method 700 can receive the RSSI from the host operating system 308 periodically or on-demand. The RSSI value can comprise a radio signal strength value represented in decibels or similar units (e.g., dbM). In step 704, method 700 can include determining if the received radio signals RSSI is within a threshold. In some embodiments, the threshold can comprise a fixed point and method 700 determines if the received RSSI is above or below the threshold. For example, the threshold may be −70 dbM, and method 700 can determine if the received RSSI is below −70 dbM. In an alternative embodiment, the threshold can include an upper and lower bound, and method 700 can determine if the received RSSI is within the upper and lower bounds. For example, the upper bound can be −70 dbM and the lower bound can be −64 dbM. In such an example, an RSSI of −69 dbM will be accepted while RSSIs of, for example, −50 dbM and −90 dbM will be rejected. In general, the threshold may be set based on performance of the system. By using a threshold, the distance in which a valid key fob will operate successfully will necessarily be limited. However, use of such a threshold increases the difficulties of amplification attacks since an attacker must be positioned in a particular location to obtain an RSSI that meets the threshold. Further, use of the radio frequency (RF) relaying makes obtaining a reliable RSSI value difficult. In step 706, method 700 can include enabling access to a vehicle in response to an RSSI value being within the threshold while in step 706, method 700 can include disabling access (step 708) to a vehicle if the RSSI value is not within the threshold.

In an embodiment, the impersonation detector 326 can be configured to authenticate a user (via key fob 200) and ensure that the user using the key fob is an authentic user with access to the vehicle 300. In an embodiment, the impersonation detector 326 can compare the biometrics received from the key fob with the biometrics stored in secure HSM 316. If the biometrics match, the impersonation detector 326 can confirm that the key fob issuing the registration command should be registered as user. In response, the impersonation detector 326 can transmit the received key fob UDI to secure key storage area 314 for secure, persistent storage. Further details of authentication module 330 are provided in FIG. 5.

In some embodiments, the outputs of secure key storage area 314 and HSM 316 must both be satisfied before the host operating system 308 will instruct the vehicle control systems 320 to allow entry to the vehicle. That is, if either of amplification detector 328 or impersonation detector 326 indicate a failure, the host operating system 308 will prevent access to the vehicle. Thus, the combination of impersonation detector 326 and amplification detector 328 ensure that an appropriate user is allowed access to the vehicle.

In an embodiment, the vehicle 300 also includes an immobilizer module 318. In general, the immobilizer module 318 is responsible for enabling and displaying ignition of the vehicle via host operating system 308 and vehicle control systems 320. In some embodiments, the immobilizer module 318 can perform a series of checks before enabling the ignition of the vehicle 300.

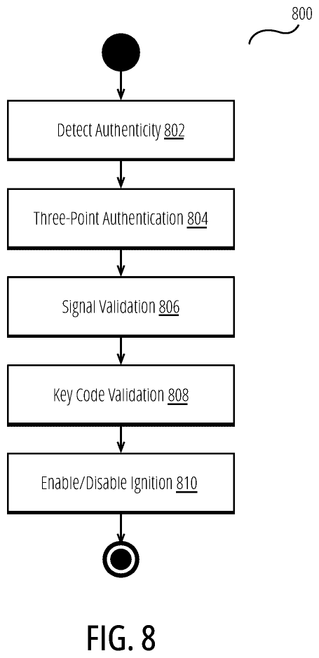

FIG. 8 is a flow diagram illustrating a method for enabling and disabling the ignition of a vehicle according to some of the example embodiments.

In a first check (step 802), the immobilizer module 318 can detect an authentic original key whose identity can be cryptographically established and verified by vehicle 300. In this check, the key fob may sign data (e.g., a nonce) using a private key. The vehicle 300 can store the corresponding public key in secure key storage area 314 during the registration process described in FIG. 4. In this check, the immobilizer module 318 can load the public key and validate the digital signature to confirm that the key fob is authentic. Since the keys may be generated based on a PUF (and thus unique to the PUF circuitry), the first check ensures that a valid key is being used and that valid key is authenticated with the vehicle 300. Thus, a cloned key will fail the first check.

In a second check (step 804), during the triangulated process of FIG. 4, the vehicle can provide its digital signature which is securely stored in the key fob (e.g., in HSM 216). In some embodiments, the key fob can transmit this digital signature, its own UDI, and the user's biometrics. These three data points can be validated against counterparts stored in vehicle 300 (e.g., in secure memory 310). If one of these values does not match, the immobilizer module 318 can disable the ignition functionality of the vehicle 300.

In a third check (step 806), the immobilizer module 318 can analyze the signal strength (described with respect to amplification detector 328) to determine if the key is valid. Further, in some embodiments, the key fob can utilize a proprietary signal pattern to modulate the underlying short-range wireless signal. In some embodiments, the immobilizer module 318 can analyze the signal to determine if this signal pattern is present and thus confirm the authenticity of a key.

Finally, in a fourth check (step 808), the immobilizer module 318 can utilize floating key codes to perform a handshake with the key. In some embodiments, a rolling code or similar mechanism can be used. Details on existing floating or rolling code security techniques are not provided for the sake of clarity. As a brief example, the key and vehicle 300 can maintain a synchronization counter among themselves. The key fob can increment the counter and encrypt the incremented counter before sending it to the vehicle 300. The vehicle 300 can then decrypt the incremented counter and determine if it is within a fixed distance (zero or potentially more to account for errors) from the expected next counter value. In some embodiments, both devices can store codes in secure memories (e.g., secure memory 310 or secure memory 210), thus increasing the security of such codes from exposure to malicious actors. Thus, in step 808, the immobilizer module 318 accesses the secure memory 310 to determine if the received key code matches the expected, golden key code stored in secure memory 310.

If each of the checks pass, in step 810, method 800 can enable ignition of the vehicle. In contrast, if any of the checks fail, method 800 can disable ignition functions of the vehicle to prevent access to the vehicle.

FIG. 4 is a sequence diagram illustrating a method for registering a key fob with a vehicle via a triangular authentication process according to some of the example embodiments.

In step 402, method 400 can include recording user biometrics. As described previously, in some embodiments, the user biometrics can comprise a biometric measurement. In some embodiments, the biometric measurement can comprise a fingerprint scan, retinal scan, iris scan, etc. The specific biometric measurement is not limiting. As illustrated, step 402 can be performed at a vehicle. In an alternative embodiment, step 402 can comprise receiving the user's biometric measurement from a third-party (e.g., a manufacturer) via a secure channel. In an embodiment, step 402 includes storing the biometric data in a secure memory. In an embodiment, step 402 includes storing the biometric data in an HSM.

In step 404, method 400 can include recording user biometrics. As described previously, in some embodiments, the user biometrics can comprise a biometric measurement. In some embodiments, the biometric measurement can comprise a fingerprint scan, retinal scan, iris scan, etc. The specific biometric measurement is not limiting. As illustrated, step 404 can be performed by a key fob or similar type of portable device. In an alternative embodiment, step 404 can comprise receiving the user's biometric measurement from a third-party (e.g., a manufacturer) via a secure channel. In an embodiment, step 404 includes storing the biometric data in a secure memory. In an embodiment, step 404 includes storing the biometric data in an HSM.

In some embodiments, the biometric measurement recorded in step 402 is of the same type as that performed in step 404. In some embodiments, the processes used in step 402 and step 404 can be selected such that the biometric measurements recorded can be comparable at later time. That is, the biometric recording algorithm can be selected to have a fidelity such that minor variations in position result in the same biometric measurement. Alternatively, as will be discussed, when comparing the biometric measurements, a threshold level of difference can be used to allow for fuzzy matches.

At the conclusion of step 404, the key fob and vehicle each store their own independently generate copies of the user biometric measurements.

In step 406, method 400 can include reading a UDI of the key fob. In some embodiments, step 406 can be executed upon starting a key registration process. In some embodiments, step 406 can include reading the UDI from an HSM in a secure memory via a validated command. As described above, the UDI of the key fob can be generated based on a PUF value of the key fob and thus can be unique to the key fob. In some embodiments, the UDI comprises a public key generated by the key fob.

In step 408, method 400 can include the key fob transmitting the biometric measurement recorded in step 404 and the UDI retrieved in step 406 to the vehicle. In some embodiments, step 408 can include transmitting the biometric measurement and UDI over a secure wireless channel. In some embodiments, step 408 can comprise transmitting the UDI and biometric measurement using a short-range wireless network such as a Bluetooth™ network.

In step 410, method 400 can include validating the biometric measurement received from the key fob. In an embodiment, step 410 can include comparing the received biometric measurement to the biometric measurement generated in step 402. In some embodiments, step 408 can comprise transmitting a hash of the biometric measurement and step 410 can comprise computing a second hash of the biometric measurement received in step 402 and comparing the hashes.

As discussed above, in some embodiments, step 410 can include determining if the received biometric measurement matches the biometric measurement stored in step 402. In general, a match indicates that the same user provided the biometric measurements to both the vehicle and the key fob. In some embodiments, a threshold can be used to determine if two biometric measurements match. Thus, an exact match may not be required and measurements that are within the threshold can be considered as matching. By matching biometric measurements, method 400 can ensure that the key fob and vehicle are being controlled by the same user.

In step 412, method 400 can include persisting the received UDI of the key fob in response to determining that the biometric measurements match. In some embodiments, step 412 can include storing the key fob UDI in an HSM of a secure memory installed in the vehicle. In some embodiments, the UDI can comprise a public key of the key fob. Alternatively, in some scenarios, if the biometric measurement comparison fails, step 412 can be bypassed (i.e., the UDI will not be persisted).

In step 414, method 400 can include returning a response to the key fob. In some scenarios, when the biometric measurement comparison passes, the response in step 414 can include a success status indicator. In some embodiments, the response can also include the UDI of the vehicle. In some embodiments, the UDI of the vehicle can comprise a public key of the vehicle generated based on a PUF value. In some scenarios, when the biometric measurement comparison fails, the response can include an error code or similar status indicator. In such a scenario, the response may not include the vehicles UDI.

In step 416, method 400 can include handling the response received in step 414. In some embodiments, step 416 can include generating an indicator of the status of the response (e.g., lighting a light-emitting diode, etc.) to provide visual feedback to the user. If the response indicates a success, step 416 can also include persisting the vehicle UDI in, for example, a secure key storage region of an HSM on the key fob.

In the foregoing embodiments of method 400, a more secure process for associating keys with vehicles is described. In addition to using biometrics to securely associate a user with a key and a vehicle, method 400 also describes a key fob authenticating itself (using biometrics) to a vehicle, thus providing a triangulated protection domain based on a combination of user biometrics and device identity keys.

FIG. 5 is a sequence diagram illustrating a method for accessing a vehicle using a key fob according to some of the example embodiments.

In step 502, method 500 can include receiving biometric data from a user and computing a biometric measurement. In some embodiments, method 500 can be performed subsequent to method 400. In an embodiment, the biometric data can comprise a fingerprint scan, retinal or iris scan, etc. In some embodiments, step 502 can further include calculating a biometric measurement from the raw biometrics. In some embodiments, step 502 can further comprise generating a hash or other one-way computation using the biometric measurement.

In some embodiments, as part of step 502, method 500 can compare the biometric measurement received in step 502 to a stored biometric measurement. In such a scenario, method 500 can terminate if the two biometric measurements do not match. However, in other embodiments, method 500 may not perform this comparison in step 502 to reduce processing complexity by the key fob. As will be discussed, in some embodiments, this comparison can be offloaded to the vehicle as part of the authentication procedure.

In step 504, method 500 can include generating a message to transmit to a vehicle. In some embodiments, the message can comprise a message requesting access to the vehicle. In some embodiments, the message can include the biometric measurement of the user. In some embodiments, the message can also include a UDI of the key fob. In some embodiments, the message can include a digital signature signed using a private key of the key fob (e.g., a private key of the UDI). In some embodiments, the UDI can comprise the public key generated using a PUF value. In some embodiments, the message can include a digital certificate associated with the UDI. In some embodiments, the digital certificate can be signed by a trusted authority. In some embodiments, step 504 can further include encrypting a payload using a private key corresponding to the UDI. As one example, the payload can include a nonce value generated by the vehicle and transmitted to the key fob prior to step 504.

In step 506, method 500 can include transmitting the message to a vehicle. In some embodiments, step 506 can include transmitting the message over a secure wireless channel. In some embodiments, step 506 can comprise transmitting the message using a short-range wireless network such as a Bluetooth™ network.

In step 508, method 500 can include receiving the message and determining if a user of the key fob can access the vehicle.

In an embodiment, during step 508, method 500 can validate a digital signature included in the message using a UDI of the key fob stored locally in the vehicle. For example, a public key received using method 400 can be accessed and used to validate the digital signature. In some embodiments, step 508 can also include validating the biometric measurement (if included). As discussed in FIG. 4, the vehicle may also store a secure copy of the biometric measurement and thus can compare the received biometric measurement to confirm a match with the expected biometric measurement (and thus user).

In step 510, if the authentication of the user and key fob is successful in step 508, method 500 can include allowing access to the vehicle. In some embodiments, step 510 can include unlocking the door of the vehicle as well as providing access to encrypted data stored in the vehicle (e.g., location history, etc.).

The use of triangulated authentication based on user biometrics enables finer grained control of a vehicle as compared to existing approaches. The following examples illustrate the types of operations enabled.

First, a vehicle can be placed in a secure service mode once the user authenticates via method 400. In this mode, the user can disable or enable certain features of the vehicle (e.g., personal navigation history) from being access if the vehicle is operated using a non-triangulated key. For example, a vehicle can include both a triangulated key fob (discussed in method 400) as well as a service or guest key fob that allows for access by non-authenticated users. Alternatively, a manufacturer of a vehicle can allow for a global guest key fob. When using the guest key fob in secure service mode, the vehicle will prevent access to those disabled features upon detecting a lack of a UDI and/or biometrics. In some embodiments, when authenticated with the key fob, the user can also define a geofence that is securely written to the secure memory of the vehicle and prevents the vehicle from being driven outside the geofence.

Second, user biometrics exchanged between the key fob and vehicle can be used to protect sensitive data. As discussed, the vehicle can include a secure memory for storing data generated by the vehicle. For example, geographic data (e.g., personal travel history), contact data, etc. can be stored in the secure memory. The vehicle's electronic systems can then be configured to only allow access to the data upon validating the UDI and user biometric measurements captured in method 400.

Third, more secure vehicle tracking can be implemented using the cryptographic data exchanged in method 400. In some embodiments, a vehicle can be configured to periodically transmit its location to a remote endpoint. Generally, if such data were transmitted in the clear, the data could easily be snooped upon by a malicious actor and the vehicle's location can be surreptitiously monitored. By contrast, in some embodiments, the vehicle can be configured to encrypt the location data in advance. In an embodiment, the vehicle can encrypt the location data using the key fob's public key. Then, when a user wishes to read the location data, the user must use the corresponding private key (which only exists on the key fob) to access the location data. In some embodiments, since the key fob is equipped with a short-range network transmitter, the key fob can be paired with a computing device (e.g., laptop, mobile device) and can be used as a decryption device to display location data. Alternatively, or in conjunction with the foregoing, once a user authenticates to a vehicle, the location data can be displayed in the vehicle.

Fourth, in some embodiments, a remote secure eSIM based interface with a vehicle will allow authorities, user, manufacturer to either remotely lock or disable the engine completely in case of a theft incident or any distress scenario like abductions of people in the vehicle.

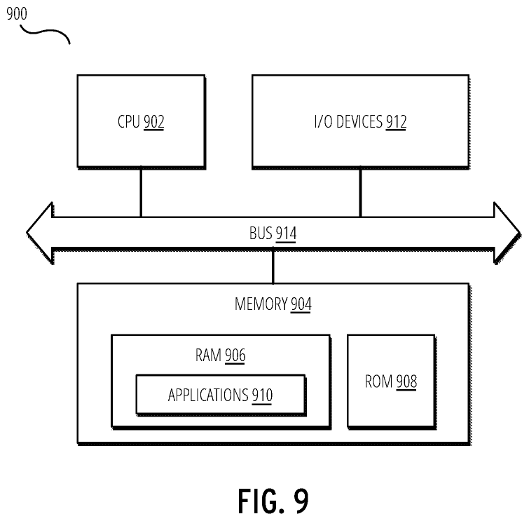

FIG. 9 is a block diagram of a computing device according to some embodiments of the disclosure.

As illustrated, the device 900 includes a processor or central processing unit (CPU) such as CPU 902 in communication with a memory 904 via a bus 914. The device also includes one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 may comprise a general-purpose CPU. The CPU 902 may comprise a single-core or multiple-core CPU. The CPU 902 may comprise a system-on-a-chip (SoC) or a similar embedded system. In some embodiments, a graphics processing unit (GPU) may be used in place of, or in combination with, a CPU 902. Memory 904 may comprise a memory system including a dynamic random-access memory (DRAM), static random-access memory (SRAM), Flash (e.g., NAND Flash), or combinations thereof. In one embodiment, the bus 914 may comprise a Peripheral Component Interconnect Express (PCIe) bus. In some embodiments, the bus 914 may comprise multiple busses instead of a single bus.

Memory 904 illustrates an example of a non-transitory computer storage media for the storage of information such as computer-readable instructions, data structures, program modules, or other data. Memory 904 can store a basic input/output system (BIOS) in read-only memory (ROM), such as ROM 908 for controlling the low-level operation of the device. The memory can also store an operating system in random-access memory (RAM) for controlling the operation of the device.

Applications 910 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 906 by CPU 902. CPU 902 may then read the software or data from RAM 906, process them, and store them in RAM 906 again.

The device may optionally communicate with a base station (not shown) or directly with another computing device. One or more network interfaces in peripheral devices 912 are sometimes referred to as a transceiver, transceiving device, or network interface card (NIC).

An audio interface in peripheral devices 912 produces and receives audio signals such as the sound of a human voice. For example, an audio interface may be coupled to a speaker and microphone (not shown) to enable telecommunication with others or generate an audio acknowledgment for some action. Displays in peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 may comprise any input device arranged to receive input from a user. An illuminator in peripheral devices 912 may provide a status indication or provide light. The device can also comprise an input/output interface in peripheral devices 912 for communication with external devices, using communication technologies, such as USB, infrared, Bluetooth®, or the like. A haptic interface in peripheral devices 912 provides tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 9, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a radio signal by a wireless transceiver installed in a vehicle;
determining that the radio signal was generated by and received from a legitimate user based on a biometric data of the legitimate user and a unique device identifier (UDI) included in the radio signal;
enabling access to the vehicle; and
enabling ignition of the vehicle based on the biometric data and the UDI.

2. The method of claim 1, wherein the radio signal includes first user biometrics stored at a key fob, and the vehicle further stores second user biometrics and the method further comprises:
confirming that the first user biometrics match the second user biometrics; and
writing the UDI to a secure memory in the vehicle.

3. The method of claim 2, wherein the UDI of the key fob comprises a public key of an asymmetric key pair.

4. The method of claim 2, wherein transmitting the first user biometrics and the UDI of the key fob to the vehicle comprises transmitting the first user biometrics and the UDI of the key fob to the vehicle via a short-range wireless network.

5. The method of claim 2, wherein confirming that the first user biometrics match the second user biometrics comprises determining if the first user biometrics are similar to the second user biometrics based on a threshold.

6. The method of claim 2, further comprising transmitting a second UDI of the vehicle to the key fob after writing the UDI to the secure memory.

7. The method of claim 1, wherein determining that the radio signal was generated by and received from a legitimate user further comprises determining a Received Signal Strength Indicator (RSSI) of the radio signal meets a threshold.

8. A non-transitory computer-readable storage medium for tangibly storing computer program instructions capable of being executed by a computer processor, the computer program instructions defining steps of:
receiving a radio signal by a wireless transceiver installed in a vehicle;
determining that the radio signal was generated by and received from a legitimate user based on a biometric data of the legitimate user and a unique device identifier (UDI) included in the radio signal;
enabling access to the vehicle; and
enabling ignition of the vehicle based on the biometric data and the UDI.

9. The non-transitory computer-readable storage medium of claim 8, wherein the radio signal includes first user biometrics stored at a key fob, and the vehicle further stores second user biometrics and the steps further comprise:
confirming that the first user biometrics match the second user biometrics; and
writing the UDI to a secure memory in the vehicle.

10. The non-transitory computer-readable storage medium of claim 9, wherein the UDI of the key fob comprises a public key of an asymmetric key pair.

11. The non-transitory computer-readable storage medium of claim 9, wherein transmitting the first user biometrics and the UDI of the key fob to the vehicle comprises transmitting the first user biometrics and the UDI of the key fob to the vehicle via a short-range wireless network.

12. The non-transitory computer-readable storage medium of claim 9, wherein confirming that the first user biometrics match the second user biometrics comprises determining if the first user biometrics are similar to the second user biometrics based on a threshold.

13. The non-transitory computer-readable storage medium of claim 9, further comprising transmitting a second UDI of the vehicle to the key fob after writing the UDI to the secure memory.

14. The non-transitory computer-readable storage medium of claim 8, wherein determining that the radio signal was generated by and received from a legitimate user further comprises determining a Received Signal Strength Indicator (RSSI) of the radio signal meets a threshold.

15. A device comprising:
a wireless transceiver; and
a processor configured to:
receive a radio signal via the wireless transceiver;
determine that the radio signal was generated by and received from a legitimate user based on a biometric data of the legitimate user and a unique device identifier (UDI) included in the radio signal;
enabling access to a vehicle housing the device; and
enabling ignition of the vehicle based on the biometric data and the UDI.

16. The device of claim 15, wherein the radio signal includes first user biometrics stored at a key fob, and the device further includes a secure memory storing second user biometrics, the processor further configured to:
confirm that the first user biometrics match the second user biometrics; and
write the UDI to a secure memory in the vehicle.

17. The device of claim 16, wherein the UDI of the key fob comprises a public key of an asymmetric key pair.

18. The device of claim 16, wherein transmitting the first user biometrics and the UDI of the key fob to the vehicle comprises transmitting the first user biometrics and the UDI of the key fob to the vehicle via a short-range wireless network.

19. The device of claim 16, wherein confirming that the first user biometrics match the second user biometrics comprises determining if the first user biometrics are similar to the second user biometrics based on a threshold.

20. The device of claim 15, wherein determining that the radio signal was generated by and received from a legitimate user further comprises determining a Received Signal Strength Indicator (RSSI) of the radio signal meets a threshold.
